(19) United States
(12) Patent Application Publication
(10) Pub. No.: US 2024/0013332 A1
(43) Pub. Date: Jan. 11, 2024

(54) LOCATION RECOMMENDATION FOR MICRO-CLIMATE MANAGEMENT

(71) Applicant: INTERNATIONAL BUSINESS MACHINES CORPORATION, ARMONK, NY (US)

(72) Inventors: Shailendra Moyal, Pune (IN); Sarbajit K. Rakshit, Kolkata (IN); Partho Ghosh, Kolkata (IN)

(21) Appl. No.: 17/811,120

(22) Filed: Jul. 7, 2022

(51) Int. Cl. G06Q 50/26; B01D 53/14

(52) U.S. Cl. CPC G06Q 50/26; B01D 53/1475

(57) ABSTRACT

According to one embodiment, a method, computer system, and computer program product for micro-environment management is provided. The embodiment may include capturing a plurality of carbon emissions data related to a plurality of carbon emissions sources in a micro-environment. The embodiment may also include capturing a plurality of carbon capture data related to a plurality of carbon capture sources in the micro-environment. The embodiment may further include generating a digital twin simulation of the micro-environment based on the plurality of captured emissions data and the plurality of captured carbon capture data. The embodiment may also include calculating a carbon absorption rate of the micro-environment based on the generated digital twin simulation. The embodiment may further include, in response to the calculated carbon absorption rate being below a threshold, generating a plan to increase the calculated carbon absorption rate in the micro-environment.

### BACKGROUND

The present invention relates generally to the field of computing, and more particularly to carbon emissions abatement.

Climate change is an ever-increasing concern in the scientific community for its potential global impact to all living things. Carbon emissions abatement relates to a field of abatement that focuses on reducing the concentration of carbon emissions in the environment. One goal of carbon emissions abatement aims to lessen the impact of climate change to improve global habitability. Carbon emissions abatement is performed through a variety of ways including, but not limited to, cleaner forms of energy (e.g., renewable energy sources), improved energy efficiency of existing technologies, and carbon capture techniques.

### SUMMARY

According to one embodiment, a method, computer system, and computer program product for micro-environment management is provided. The embodiment may include capturing a plurality of carbon emissions data related to a plurality of carbon emissions sources in a micro-environment. The embodiment may also include capturing a plurality of carbon capture data related to a plurality of carbon capture sources in the micro-environment. The embodiment may further include generating a digital twin simulation of the micro-environment based on the plurality of captured emissions data and the plurality of captured carbon capture data. The embodiment may also include calculating a carbon absorption rate of the micro-environment based on the generated digital twin simulation. The embodiment may further include, in response to the calculated carbon absorption rate being below a threshold, generating a plan to increase the calculated carbon absorption rate in the micro-environment.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a micro-environment management process according to at least one embodiment.

FIG. 3 is a block diagram of internal and external components of computers and servers depicted in FIG. 1 according to at least one embodiment.

FIG. 4 depicts a cloud computing environment according to an embodiment of the present invention.

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to carbon emissions abatement. The following described exemplary embodiments provide a system, method, and program product to, among other things, identify carbon dioxide spread and concentrations throughout a preconfigured environment through carbon emissions data, flora carbon absorption data, and weather data and, through digital twin simulations, generate a carbon abatement plan for the preconfigured environment. Therefore, the present embodiment has the capacity to improve the technical field of carbon emissions abatement by maximizing carbon abatement potential in the preconfigured environment.

As previously described, climate change is an ever-increasing concern in the scientific community for its potential global impact to all living things. Carbon emissions abatement relates to a field of abatement that focuses on reducing the concentration of carbon emissions in the environment. One goal of carbon emissions abatement aims to lessen the impact of climate change to improve global habitability. Carbon emissions abatement is performed through a variety of ways including, but not limited to, cleaner forms of energy (e.g., renewable energy sources), improved energy efficiency of existing technologies, and carbon capture techniques.

Carbon capture relates to a technique of carbon abatement by withdrawing harmful carbon gases (e.g., carbon dioxide) from the air, separating the captured gases through one of a variety of separation technologies (e.g., oxyfuel combustion, adsorption, chemical looping combustion, calcium looping, cryogenics, etc.), and storing the separated carbon (e.g., geological storage, algal/bacterial breakdown processes, and mineral storage). Many standard carbon capture techniques are most efficient and cost effective at the point sources of carbon emissions, such as carbon-based power plants, natural gas processing centers, and fossil fuel-based production plants. Utilization of typical carbon capture techniques for non-source points may not only be less efficient but cost ineffective enough for adoption. For example, an urban environment may have many small emissions points, such as vehicles, chimneys, factories, and living organisms.

However, natural processes (i.e., photosynthesis) in flora provide many of the same advantages as the mentioned carbon capture techniques. Recently, artificial intelligence improvements have provided metrics on the rate of carbon dioxide absorption a given tree can capture. As such, it may be advantageous to, among other things, utilize digital twin simulation of a smart environment (e.g., a smart city) to coordinate the location and amount of flora to place around a smart device-enabled environment may provide sufficient carbon capture processes to effectively curb excess release of carbon dioxide into the air.

According to at least one embodiment, data related to carbon emissions, carbon capture, and environmental weather in a preconfigured area may be gathered and analyzed to aid in the generation of a digital twin simulation of the preconfigured area. The digital twin simulation may in turn be utilized to generate a carbon abatement plan in the preconfigured area where various flora elements, or other carbon capture techniques, may be either temporarily or permanently placed throughout the preconfigured area to locations with the highest carbon concentration.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above

The following described exemplary embodiments provide a system, method, and program product for carbon emissions abatement through the use of flora elements, or other carbon capture techniques, strategically placed throughout a preconfigured area as determined by a digital twin simulation of the preconfigured area.

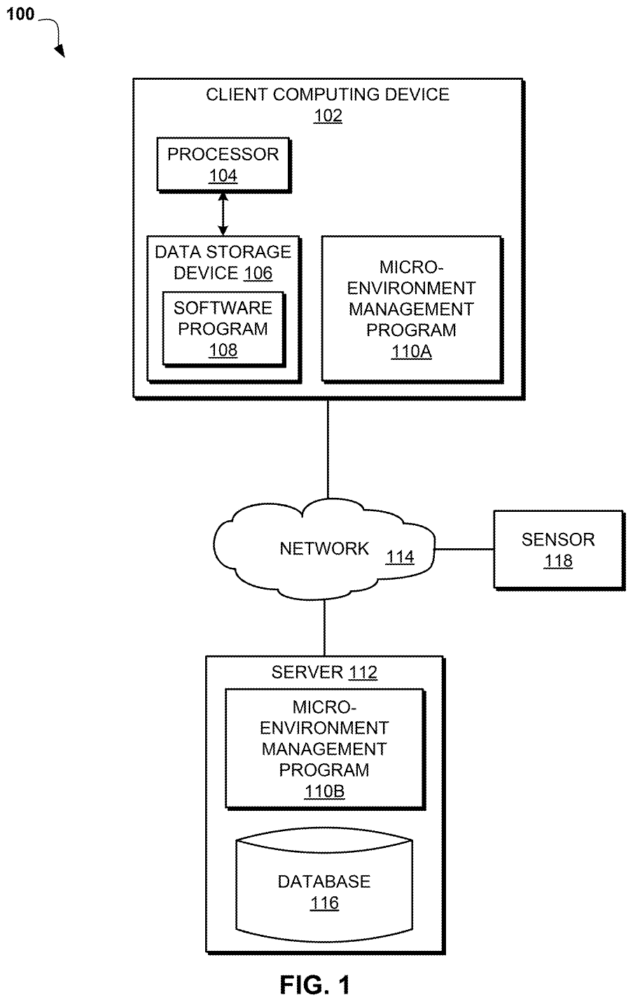

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102, servers 112, and sensors 118, of which only one of each is shown for illustrative brevity. Additionally, in one or more embodiments, the client computing device 102 and server 112 may each individually host a micro-environment management program 110A, 110B. In one or more other embodiments, the micro-environment management program 110A, 110B may be partially hosted on both the client computing device 102 and the server 112 so that functionality may be separated between the devices.

The communication network 114 may include various types of communication networks, such as a wide area network (WAN), local area network (LAN), a telecommunication network, a wireless network, a wireless ad hoc network (i.e., a wireless mesh network), a public switched network, a radio frequency (RF) network, and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

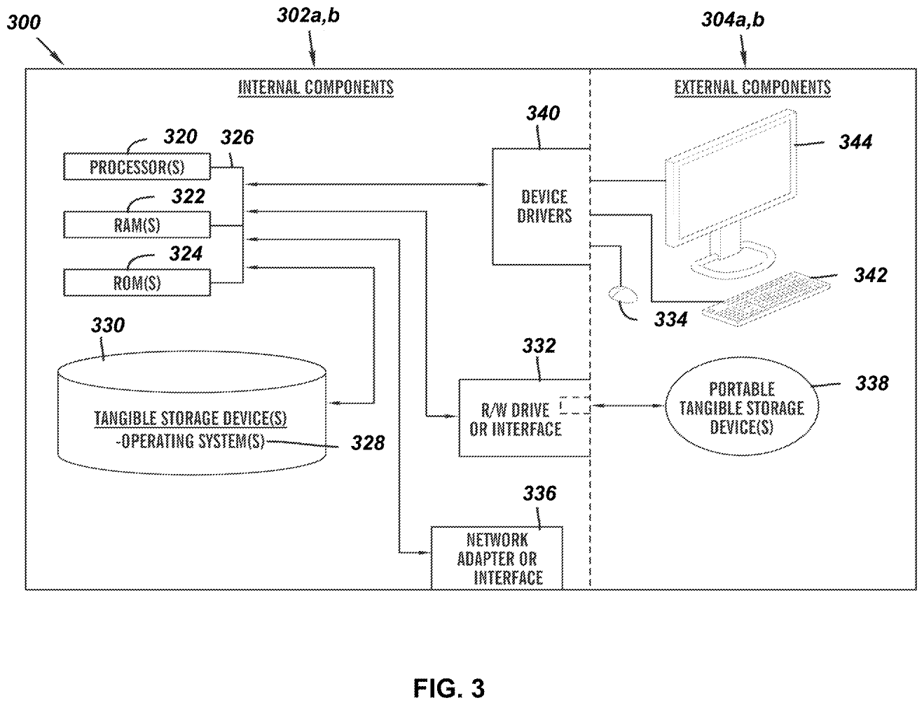

Client computing device 102 may include a processor 104 and a data storage device 106 that is enabled to host and run a software program 108 and the micro-environment management program 110A and communicate with the server 112 via the communication network 114, in accordance with one embodiment of the invention. In one or more other embodiments, client computing device 102 may be, for example, a mobile device, a smartphone, a personal digital assistant, a netbook, a laptop computer, a tablet computer, a desktop computer, or any type of computing device capable of running a program and accessing a network. As previously described, one client computing device 102 is depicted in FIG. 1 for illustrative purposes, however, any number of client computing devices 102 may be utilized. As will be discussed with reference to FIG. 3, the client computing device 102 may include internal components 302a and external components 304a, respectively.

The server computer 112 may be a laptop computer, netbook computer, personal computer (PC), a desktop computer, or any programmable electronic device or any network of programmable electronic devices capable of hosting and running the micro-environment management program 110B and a database 116 and communicating with the client computing device 102 via the communication network 114, in accordance with embodiments of the invention. As will be discussed with reference to FIG. 3, the server computer 112 may include internal components 302b and external components 304b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

Sensor 118 may be any device capable of capturing environmental data for assessing the quality of air within an environment, such as an air sensor or a regulatory air monitor. In at least one embodiment, the sensor 118 may estimate the concentration of a pollutant in the air, such as carbon dioxide, carbon monoxide, ozone, nitrogen oxide, particular matter, or any other pollutant capable of measurement by a sensor. Sensor 118 may be capable of capturing various other data points in addition to air quality including, but not limited to, temperature, wind speed, barometric pressure, light intensity, etc. According to at least one implementation, only one sensor 118 is shown for illustrative brevity. Any number of sensors 118 may utilized in the networked computer environment 100. In at least one embodiment, the sensor 118 may be capable of transmitting the captured environmental data to client computing device 102 and/or server 112. In yet another embodiment, sensor 118 may be an image capture device, such as a camera, capable of gathering image data of elements surrounding the sensor 118.

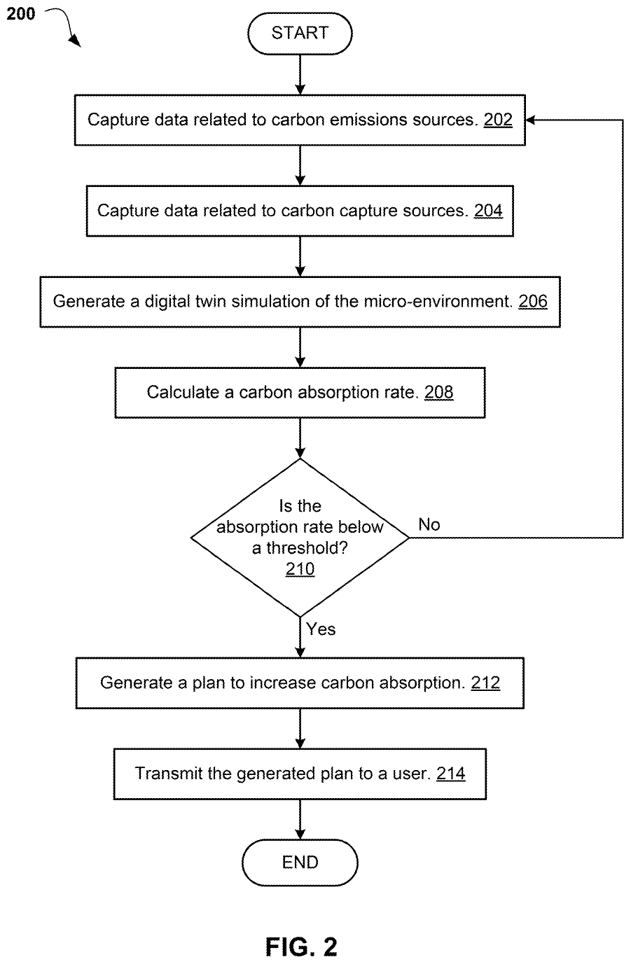

According to the present embodiment, the micro-environment management program 110A, 110B may be capable of receiving captured air quality data, such as carbon emissions data and carbon capture data, from one or more sensors 118 and generating a digital twin simulation of a micro-environment, in order to calculate an emissions distribution as well as a carbon absorption pattern throughout the micro-environment. The micro-environment management program 110A, 110B may utilize the emissions distribution realized from the digital twin simulation to generate a carbon abatement plan within the micro-environment and distributing the carbon abatement plan to one or more users. The micro-environment management method is explained in further detail below with respect to FIG. 2.

Referring now to FIG. 2, an operational flowchart for a micro-environment management process 200 is depicted according to at least one embodiment. At 202, the micro-environment management program 110A, 110B captures data related to carbon emissions sources within a micro-environment. In at least one embodiment, the micro-environment may be any preconfigured area of definite size. For example, the micro-environment may be a state, metropolitan area, city, town, village, block, building, house, apartment, or any indoor or outdoor space defined by a user. The micro-environment management program 110A, 110B may capture data, such as carbon dioxide emissions data, through the deployment of one or more sensors 118 throughout the micro-environment. For example, the micro-environment management program 110A, 110B may gather data, such as air flow direction, air flow speed, and carbon dioxide concentration level within sampled air (e.g., parts per million or parts per billion of carbon dioxide). As previously described, the one or more sensors may estimate the concentration of a pollutant in the air as well as capturing images and various other data points relating to air quality including, but not limited to, temperature, wind speed, barometric pressure, light intensity, etc.

In at least one embodiment, the micro-environment management program 110A, 110B may also identify one or more carbon emissions sources within the micro-environment, such as vehicles, residences, factories, commercial establishments, industrial facilities, or any entity that expels carbon-related emissions. The micro-environment management program 110A, 110B may identify a carbon emissions source through detection of a carbon concentration within the air, as detected by one or more sensors 118 capable of calculating carbon concentration, exceeding a threshold value and capture an image or video of the area in the micro-environment from which the high carbon concentration was detected using one or more sensors 118 with photographic capture capabilities. The carbon emissions sources may then be identified through image recognition techniques of satellite imagery from a third-party and/or publicly available repository, such as database 116. For example, a satellite image of a location with a carbon concentration exceeding the preconfigured threshold may be analyzed with image recognition technology to identify the carbon emissions source as a factory.

In at least one embodiment, the micro-environment management program 110A, 110B may take into consideration various attributes of the carbon emissions sources, such as, but not limited to, age and condition of each identified carbon emissions source (e.g., factories, vehicles, residences, etc.). The micro-environment management program 110A, 110B may utilize third party repositories, such as database 116, to estimate the emissions from the identified carbon emissions sources in order to accurately reflect emissions in the digital twin simulation.

In at least one other embodiment, the micro-environment management program 110A, 110B may connect to IoT devices, such as smart home or smart building devices, to identify when peak cycles of carbon emissions may take place. For example, after a user opts-in to allowing the sharing of data with the micro-environment management program 110A, 110B, a smart thermostat may transmit data related to home heating and cooling schedules of an HVAC system fueled by fossil fuel sources as preconfigured by a user. Capturing such information may allow the micro-environment management program 110A, 110B to predict when certain carbon emissions sources will likely produce more emissions in a cyclical manner thus allowing the micro-environment management program 110A, 110B to adjust a carbon abatement plan accordingly.

In yet another embodiment, the micro-environment management program 110A, 110B may identify a carbon concentration (e.g., carbon dioxide concentration) in non-source locations. For example, if carbon dioxide is stronger in one area of a residential building, the micro-environment management program 110A, 110B may identify this non-source location as an area that accumulates more carbon dioxide in comparison to other locations in the micro-environment and, therefore, may need more carbon capture than other areas.

Then, at 204, the micro-environment management program 110A, 110B captures data related to carbon capture sources. Similar to utilizing sensors, such as sensor 118, to identify sources of carbon emissions, the micro-environment management program 110A, 110B may also utilize sensors to identify sources of carbon capture within the micro-environment. A carbon capture source may be identified as any entity that is capable of absorbing, or otherwise removing, carbon matter, such as carbon dioxide, from the air. For example, a common carbon capture technology is carbon scrubbing of the air using amines. An additional example may be observed in the natural photosynthesis process where carbon dioxide, sunlight, and water are absorbed by local flora and oxygen and sugar are subsequently produced.

The micro-environment management program 110A, 110B may identify the carbon capture sources through image recognition of the micro-environment. For example, the micro-environment management program 110A, 110B may analyze satellite imagery from a third-party and/or publicly available repository, such as database 116, to identify the location of trees and bushes located throughout the micro-environment. Furthermore, the micro-environment management program 110A, 110B may also identify carbon capture sources through manual identification. For example, a user, such as a developer or administrator of the micro-environment, may manually indicate on a map or overlay of the micro-environment the location and relevant metadata associated with each carbon capture source, such as, but not limited to, age, type of carbon capture technology, and carbon capture rate.

In at least one embodiment, the micro-environment management program 110A, 110B may identify various aspects of each carbon capture source indicative to the carbon capture source's carbon capture capabilities. For example, if the carbon capture source is an item of flora, the micro-environment management program 110A, 110B may identify the item's age, height, carbon absorption surface area, hibernation status, health status, light exposure, water exposure, and emitted carbon exposure.

Next, at 206, the micro-environment management program 110A, 110B generates a digital twin simulation of the smart environment. Digital twin simulation relates to the generation of a virtual model of a physical entity that accurately reflects aspects of the physical entity being replicated. The micro-environment management program 110A, 110B may utilize various items of sensor data to generate the digital twin, such as image recognition of satellite imagery, topographical maps, weather data, traffic data, the captured data relating to carbon capture sources, and the captured data relating to carbon emissions sources. For example, the micro-environment management program 110A, 110B may generate a digital twin simulation of a preconfigured area, such as a city block, through an analysis of satellite imagery of the city block as well as data gathered from various sensors, such as sensor 118, deployed throughout the city block, such as cameras, anemometers, thermometers, barometers, carbon concentration meters, and light sensors. The generated digital twin simulation may be capable of visualizing and calculating the carbon emissions rates from each identified carbon emissions source, the propagation of carbon emissions from each source throughout the micro-environment, and the absorption rate of each identified carbon capture source within the micro-environment.

Then, at 208, the micro-environment management program 110A, 110B calculates a carbon absorption rate. The micro-environment management program 110A, 110B may perform analysis on the generated digital twin to calculate the carbon absorption rate within the preconfigured area. The digital twin simulation may consider the captured carbon emissions data from step 202 and the captured carbon capture data from step 204 to calculate the carbon absorption rate for the micro-environment. For example, the micro-environment management program 110A, 110B may be able to calculate a cumulative emission rate for carbon emissions sources in the micro-environment and, based on a calculated dispersion throughout the micro-environment based on environmental factors (e.g., wind speed, wind direction, current and/or forecast precipitation, temperature, humidity level, etc.), calculate an absorption rate of the emitted carbon by the identified carbon capture sources in the micro-environment.

In at least one embodiment, the carbon absorption rate may be calculated as the carbon emissions rate within the micro-environment subtracted by the carbon capture rate. Therefore, any value greater than zero indicates more carbon is absorbed in the micro-environment than is being emitted, any value less than zero indicates more carbon is being emitted in the micro-environment than is being captured, and a value equal to zero means all the carbon emitted in the micro-environment is being captured.

In at least one other embodiment, the carbon absorption rate may be calculated as the carbon capture rate within the micro-environment divided by the carbon emissions rate. Therefore, any value greater than one indicates more carbon is absorbed in the micro-environment than is being emitted, any value less than one indicates more carbon is being emitted in the micro-environment than is being captured, and a value equal to one means all the carbon emitted in the micro-environment is being captured.

Next, at 210, the micro-environment management program 110A, 110B determines whether the absorption rate is below an absorption rate threshold. In at least one embodiment, the absorption rate threshold may be a preconfigured value that aims to equally offset or improve the air quality through carbon capture. For example, in the situation where the carbon absorption rate is calculated as the carbon emissions rate subtracted by the carbon capture rate, the preconfigured absorption rate threshold may be preconfigured by a user as being any value greater than or equal to zero since that figure would equate to the rate of carbon emissions being offset or exceeded by the rate of carbon capture. Similarly, in the situation where the carbon absorption rate is calculated as the carbon capture rate divided by the carbon emissions rate, the preconfigured absorption rate threshold may be viewed as any numeric value greater than or equal to one since that figure would equate to the rate of carbon emissions being offset or exceeded by the rate of carbon capture.

In at least one embodiment, the micro-environment management program 110A, 110B may determine that the absorption rate of the micro-environment is below a threshold based on comparison of the calculated carbon absorption rate to the preconfigured threshold. If the micro-environment management program 110A, 110B determines the absorption rate is below a threshold (step 210, “Yes” branch), then the micro-environment management process 200 may proceed to step 212 to generate a plan to increase carbon absorption. If the micro-environment management program 110A, 110B determines the absorption rate is at or above the threshold (step 210, “No” branch), then the micro-environment management process 200 may return to step 202 to capture data related to carbon emissions sources.

In at least one other embodiment, the micro-environment management program 110A, 110B may allow the absorption rate to exceed the preconfigured absorption rate threshold until the concentration of carbon in the air reaches a second threshold, or a concentration threshold. For example, if the concentration threshold for carbon dioxide in the air is preconfigured to 1,000 parts per million (ppm), the micro-environment management program 110A, 110B may allow the carbon absorption rate to exceed the absorption rate threshold until the concentration of carbon dioxide in the air satisfies the concentration threshold of 1,000 ppm of carbon dioxide.

Then, at 212, the micro-environment management program 110A, 110B generates a plan to increase the carbon absorption. Once the micro-environment management program 110A, 110B determines that the carbon absorption within the micro-environment is below a preconfigured absorption threshold, the micro-environment management program 110A, 110B may generate a plan to increase the carbon absorption based on the digital simulation. The micro-environment management program 110A, 110B may identify and utilize one or more carbon capture technologies at one or more location identified by the micro-environment management program 110A, 110B throughout the micro-environment most appropriate to achieve the goal of improved carbon absorption. For example, if the micro-environment is an indoor dwelling, the micro-environment management program 110A, 110B may determine strategic placement of one or more houseplants may provide adequate carbon capture to improve the carbon absorption rate below the absorption threshold. When determining which carbon capture method is most appropriate for the micro-environment, the micro-environment management program 110A, 110B may calculate a total rate of improvement needed to return the carbon absorption to or below the absorption threshold. For example, a carbon absorption rate severely below the threshold may require more than one carbon capture technologies to return the carbon absorption rate and/or carbon concentration in the air to the threshold level. The micro-environment management program 110A, 110B may select one or more carbon capture technologies most suitable to improve carbon capture for the specific attributes of the micro-environment. Once the micro-environment management program 110A, 110B selects specific methods of carbon capture and which locations to deploy the selected methods, the micro-environment management program 110A, 110B may mark an electronic map of the micro-environment with details related to the location and type of carbon capture to be deployed. For example, if trees are to be planted in the micro-environment, the micro-environment management program 110A, 110B may indicate on an electronic map the location of each planting and the type, age, and size of the trees in need of planting.

In at least one embodiment, when the planting of flora is the selected method of carbon capture, the micro-environment management program 110A, 110B may be capable of identifying the most appropriate item of flora for a given location and carbon concentration. The micro-environment management program 110A, 110B may be capable of selecting a flora type (e.g., tree, bush, shrub, flowers, vines, etc.) and species suited for improving the carbon capture. For example, the micro-environment management program 110A, 110B may determine that an indoor, residential micro-environment with only a minor dip below the carbon absorption threshold may be best suited for the deployment of several small houseplants whereas an urban city block may be better suited for the deployment of large trees capable of greater carbon capture.

Additionally, the micro-environment management program 110A, 110B may identify one or more locations within the micro-environment most suitable for installation of a carbon capture method. Such locations may be identified as areas with the highest carbon concentrations in the micro-environment. For example, the micro-environment management program 110A, 110B may identify a portion of an urban micro-environment furthest from a park to be most suitable for the permanent or temporary planting of high carbon dioxide absorbing flora.

In at least one embodiment, the micro-environment management program 110A, 110B may utilize transportation technology, such as unmanned aerial vehicles or trolley systems, to transport the carbon capture methods to one or more locations within the micro-environment deemed most appropriate for carbon capture supplementation. For example, in an urban environment, the micro-environment management program 110A, 110B may identify a series of locations in need of supplementation for carbon capture and dispatch one or more units of transportation to deploy one or more items of flora. The transportation technology systems may deliver the carbon capture technologies to the identified locations and, upon the expiration of a preconfigured period of time or the return of carbon concentration level in the air to threshold levels, remove the carbon capture technologies. For example, an unmanned aerial vehicle may deliver a series of potted trees along a city block identified by the micro-environment management program 110A, 110B as having high carbon dioxide concentrations. Upon the return of carbon dioxide concentrations to a threshold level, the unmanned aerial vehicle may remove the potted trees to a storage location.

Next, at 214, the micro-environment management program 110A, 110B transmits the generated plan to a user. Once the micro-environment management program 110A, 110B generates the plan for carbon absorption in the micro-environment, the micro-environment management program 110A, 110B may transmit the generated plan to the user for approval. The generated plan may be transmitted to the user through any variety of methods for electronic transmission, such as, but not limited to, email, SMS text message, application push notification, and direct file transfer. Furthermore, the micro-environment management program 110A, 110B may allow the user to observe and interact with the transmitted plan through a graphical user interface associated with a user device, such as client computing device 102.

It may be appreciated that FIG. 2 provides only an illustration of one implementation and does not imply any limitations with regard to how different embodiments may be implemented. Many modifications to the depicted environments may be made based on design and implementation requirements.

In at least one embodiment, flora temporarily deployed by the micro-environment management program 110A, 110B may be equipped with horticultural care technologies. For example, potted trees delivered to the identified locations of high carbon concentration may be equipped with automated watering and fertilization systems should the need for water or fertilizer need to be supplemented during the flora's deployment. In at least one other embodiment, the micro-environment management program 110A, 110B may monitor the levels of the deployed horticultural care technologies and notify a system administrator during low levels of any medium. For example, if an automated watering system experiences low water level in a storage tank, the micro-environment management program 110A, 110B may notify a user of the low water levels. In such situations, transportation technologies, such as unmanned aerial vehicles, may be equipped to deliver and replenish the diminished media.

In at least one other embodiment, the micro-environment management program 110A, 110B may continually monitor the carbon absorption and concentration levels within the micro-environment and update the generated plan to optimize absorption as needed. For example, since carbon concentrations may vary with time of day (e.g., rush hour traffic), carbon capture technologies may be needed closer to roadways during specific hours of the day whereas other times of the day (e.g., second shift hours) the carbon capture technologies may be needed closer to factories with higher carbon emissions.

In yet another embodiment, the micro-environment management program 110A, 110B may monitor the deployed carbon capture technologies and/or methods for needed maintenance. For example, regular maintenance may be needed after a specific time frame for certain carbon capture technologies (e.g., filter change or machine cleaning). Similarly, flora used for photosynthesis removal of carbon dioxide may require fertilization and/or trimming in order to maintain an adequate size and avoid overgrowth that may compromise the flora's integrity. Such monitoring may be performed through image analysis of satellite imagery and/or through schedule notifications after a preconfigured period of time. When the micro-environment management program 110A, 110B determines maintenance should be recommended, a notification (e.g., an email or SMS notification) may be transmitted to a user device, such as client computing device 102.

In still another embodiment, the micro-environment management program 110A, 110B may provide a recommendation to a user, such as a city or building administrator, as to the number of vehicles or entities that should be permitted into the micro-environment based on the current carbon absorption and emissions rates. For example, if a building has a certain normal carbon emissions and absorption rate but the building is scheduled to host a conference where the number of attendees in the building may cause the carbon emissions rate within the building to exceed the absorption threshold and/or the concentration threshold, the micro-environment management program 110A, 110B may notify the user that regulation of the number of individuals within the micro-environment should be regulated to avoid exceeding the absorption threshold and/or the concentration threshold. Similarly, the micro-environment management program 110A, 110B may present a carbon abatement plan to the user based on the predicted carbon emissions based on the digital twin simulation. Additionally, the micro-environment management program 110A, 110B may restrict various carbon dioxide generation sources in the micro-environment in order to control the release of carbon into the micro-environment. Such regulation by the micro-environment management program 110A, 110B may only impact non-critical systems that generate carbon dioxide and may also require user, such as building or city administrator, approval prior to regulation by the micro-environment management program 110A, 110B.

FIG. 3 is a block diagram 300 of internal and external components of the client computing device 102 and the server 112 depicted in FIG. 1 in accordance with an embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

The data processing system 302, 304 is representative of any electronic device capable of executing machine-readable program instructions. The data processing system 302, 304 may be representative of a smart phone, a computer system, PDA, or other electronic devices. Examples of computing systems, environments, and/or configurations that may represented by the data processing system 302, 304 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 302 a,b and external components 304 a,b illustrated in FIG. 3. Each of the sets of internal components 302 include one or more processors 320, one or more computer-readable RAMs 322, and one or more computer-readable ROMs 324 on one or more buses 326, and one or more operating systems 328 and one or more computer-readable tangible storage devices 330. The one or more operating systems 328, the software program 108 and the micro-environment management program 110A in the client computing device 102 and the micro-environment management program 110B in the server 112 are stored on one or more of the respective computer-readable tangible storage devices 330 for execution by one or more of the respective processors 320 via one or more of the respective RAMs 322 (which typically include cache memory). In the embodiment illustrated in FIG. 3, each of the computer-readable tangible storage devices 330 is a magnetic disk storage device of an internal hard drive. Alternatively, each of the computer-readable tangible storage devices 330 is a semiconductor storage device such as ROM 324, EPROM, flash memory or any other computer-readable tangible storage device that can store a computer program and digital information.

Each set of internal components 302 a,b also includes a RAY drive or interface 332 to read from and write to one or more portable computer-readable tangible storage devices 338 such as a CD-ROM, DVD, memory stick, magnetic tape, magnetic disk, optical disk or semiconductor storage device. A software program, such as the micro-environment management program 110A, 110B, can be stored on one or more of the respective portable computer-readable tangible storage devices 338, read via the respective RAY drive or interface 332, and loaded into the respective hard drive 330.

Each set of internal components 302 a,b also includes network adapters or interfaces 336 such as a TCP/IP adapter cards, wireless Wi-Fi interface cards, or 3G, 4G, or 5G wireless interface cards or other wired or wireless communication links. The software program 108 and the micro-environment management program 110A in the client computing device 102 and the micro-environment management program 110B in the server 112 can be downloaded to the client computing device 102 and the server 112 from an external computer via a network (for example, the Internet, a local area network or other, wide area network) and respective network adapters or interfaces 336. From the network adapters or interfaces 336, the software program 108 and the micro-environment management program 110A in the client computing device 102 and the micro-environment management program 110B in the server 112 are loaded into the respective hard drive 330. The network may comprise copper wires, optical fibers, wireless transmission, routers, firewalls, switches, gateway computers and/or edge servers.

Each of the sets of external components 304 a,b can include a computer display monitor 344, a keyboard 342, and a computer mouse 334. External components 304 a,b can also include touch screens, virtual keyboards, touch pads, pointing devices, and other human interface devices. Each of the sets of internal components 302 a,b also includes device drivers 340 to interface to computer display monitor 344, keyboard 342, and computer mouse 334. The device drivers 340, RAY drive or interface 332, and network adapter or interface 336 comprise hardware and software (stored in storage device 330 and/or ROM 324).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

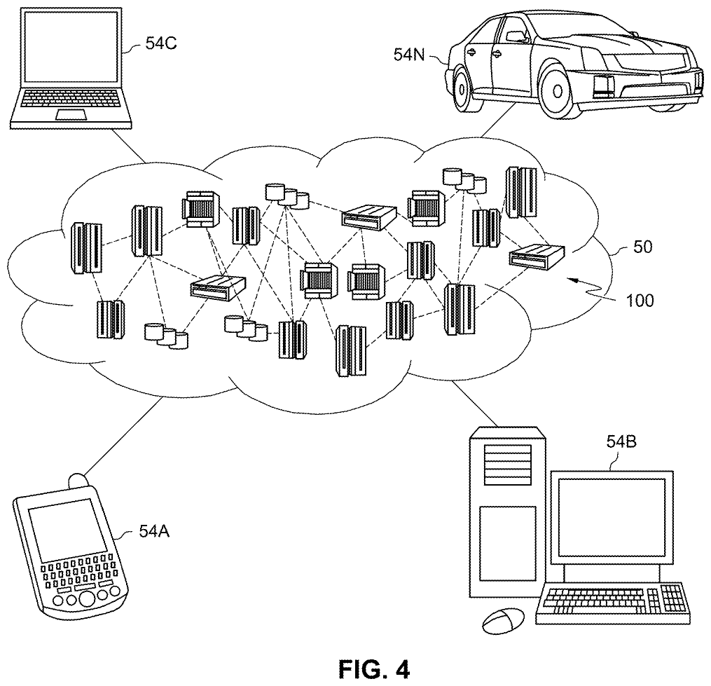

Referring now to FIG. 4, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 100 and cloud computing environment 50 can communicate with any type of computerized device over any type of network and/or network addressable connection (e.g., using a web browser).

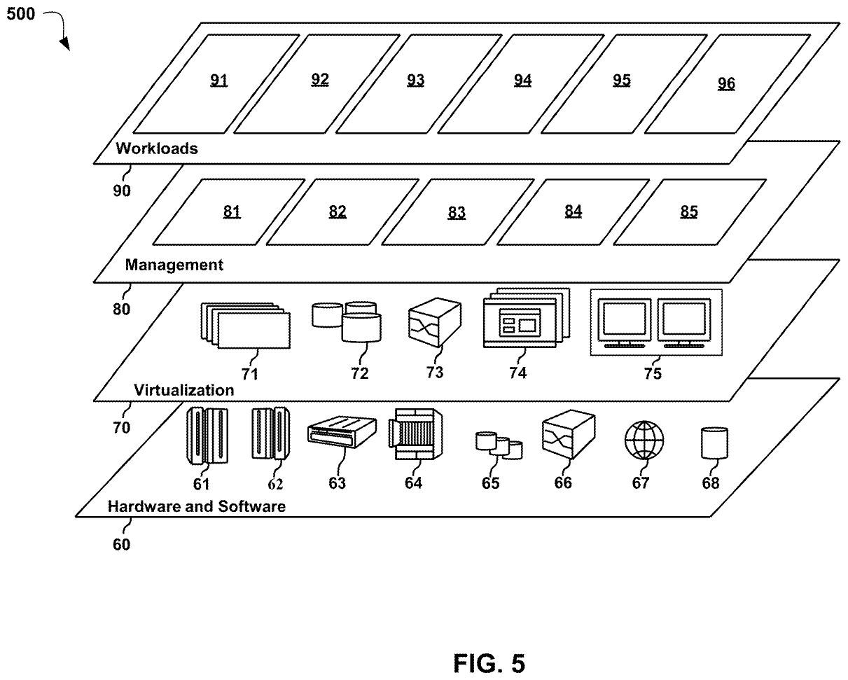

Referring now to FIG. 5, a set of functional abstraction layers 500 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and micro-environment management 96. Micro-environment management 96 may relate to gathering carbon emission and carbon absorption data within a preconfigured area in order to generate a digital twin simulation of the area and a carbon abatement plan that increases the carbon absorption rates of entities within the area.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
capturing, by a processor, a plurality of carbon emissions data related to a plurality of carbon emissions sources in a micro-environment;
capturing a plurality of carbon capture data related to a plurality of carbon capture sources in the micro-environment;
generating a digital twin simulation of the micro-environment based on the plurality of captured emissions data and the plurality of captured carbon capture data;
calculating a carbon absorption rate of the micro-environment based on the generated digital twin simulation; and
in response to the calculated carbon absorption rate being below a threshold, generating a plan to increase the calculated carbon absorption rate in the micro-environment.

2. The method of claim 1, wherein the generated plan comprises deploying one or more carbon capture techniques to one or more locations throughout the micro-environment.

3. The method of claim 2, wherein a carbon capture technique of the one or more carbon capture techniques comprises placing or planting one or more items of flora at the one or more locations.

4. The method of claim 3, wherein the one or more items of flora placed or planted at the one or more locations are chosen based on a type of flora and a species of flora.

5. The method of claim 2, wherein the one or more locations are identified as areas within the micro-environment with a highest carbon dioxide concentration.

6. The method of claim 4, wherein the placing or the planting are performed by one or more transportation technologies capable of transporting the one or more carbon capture techniques to the one or more locations.

7. The method of claim 1, further comprising:
monitoring the carbon absorption rate in the micro-environment after implementation of the plan; and
updating the plan based on the monitored carbon absorption rate.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
capturing a plurality of carbon emissions data related to a plurality of carbon emissions sources in a micro-environment;
capturing a plurality of carbon capture data related to a plurality of carbon capture sources in the micro-environment;
generating a digital twin simulation of the micro-environment based on the plurality of captured emissions data and the plurality of captured carbon capture data;
calculating a carbon absorption rate of the micro-environment based on the generated digital twin simulation; and
in response to the calculated carbon absorption rate being below a threshold, generating a plan to increase the calculated carbon absorption rate in the micro-environment.

9. The computer system of claim 8, wherein the generated plan comprises deploying one or more carbon capture techniques to one or more locations throughout the micro-environment.

10. The computer system of claim 9, wherein a carbon capture technique of the one or more carbon capture techniques comprises placing or planting one or more items of flora at the one or more locations.

11. The computer system of claim 10, wherein the one or more items of flora placed or planted at the one or more locations are chosen based on a type of flora and a species of flora.

12. The computer system of claim 9, wherein the one or more locations are identified as areas within the micro-environment with a highest carbon dioxide concentration.

13. The computer system of claim 11, wherein the placing or the planting are performed by one or more transportation technologies capable of transporting the one or more carbon capture techniques to the one or more locations.

14. The computer system of claim 8, further comprising:
monitoring the carbon absorption rate in the micro-environment after implementation of the plan; and
updating the plan based on the monitored carbon absorption rate.

15. A computer program product, the computer program product comprising:
one or more computer-readable tangible storage medium and program instructions stored on at least one of the one or more tangible storage medium, the program instructions executable by a processor capable of performing a method, the method comprising:
capturing a plurality of carbon emissions data related to a plurality of carbon emissions sources in a micro-environment;
capturing a plurality of carbon capture data related to a plurality of carbon capture sources in the micro-environment;
generating a digital twin simulation of the micro-environment based on the plurality of captured emissions data and the plurality of captured carbon capture data;
calculating a carbon absorption rate of the micro-environment based on the generated digital twin simulation; and
in response to the calculated carbon absorption rate being below a threshold, generating a plan to increase the calculated carbon absorption rate in the micro-environment.

16. The computer program product of claim 15, wherein the generated plan comprises deploying one or more carbon capture techniques to one or more locations throughout the micro-environment.

17. The computer program product of claim 16, wherein a carbon capture technique of the one or more carbon capture techniques comprises placing or planting one or more items of flora at the one or more locations.

18. The computer program product of claim 17, wherein the one or more items of flora placed or planted at the one or more locations are chosen based on a type of flora and a species of flora.

19. The computer program product of claim 16, wherein the one or more locations are identified as areas within the micro-environment with a highest carbon dioxide concentration.

20. The computer program product of claim 18, wherein the placing or the planting are performed by one or more transportation technologies capable of transporting the one or more carbon capture techniques to the one or more locations.
